(19) United States
(12) Patent Application Publication
(10) Pub. No.: US 2008/0120720 A1
(43) Pub. Date: May 22, 2008

(54) Intrusion detection via high dimensional vector matching

(76) Inventors: Jinhong Guo, West Windsor, NJ (US); Daniel Weber, Moriguchi-City (JP); Stephen Johnson, Erdenheim, PA (US); Il-Pyung Park, Princeton Junction, NJ (US)

Correspondence Address: GREGORY A. STOBBS, 5445 CORPORATE DRIVE, SUITE 400, TROY, MI, 48098, US

(21) Appl. No.: 11/601,864

(22) Filed: Nov. 17, 2006

(51) Int. Cl. G06F 21/00

(52) U.S. Cl. 726/23

(57) ABSTRACT

A method is provided for detecting intrusions to a computing environment. The method includes: monitoring system calls made to an operating system during a defined period of time; evaluating the system calls made during the defined time period in relation to system calls made during known intrusions; and evaluating the temporal sequence in which system calls were made during the defined time period when the system calls made match the system calls made during a known intrusion. If a potential intrusion is detected at this stage, then a more complicated detection scheme may be performed by a second detection scheme. For instance, the second detection scheme may assess the temporal sequence in which the system calls were made and/or the system files accessed by the system calls.

### FIELD

The present disclosure relates generally to computer security and, more particularly, to techniques for detecting intrusions in a computing environment.

### BACKGROUND

Malicious code can be classified into virus, worm, Trojan horse, etc. Regardless of the function each malicious code performs, it follows certain patterns of behavior that should be considered abnormal in a system. For example, a typical worm scans for ports. It may also send out numerous emails in a short duration of time.

Since lots of attacks happen through the network, much work has been done in detecting network traffic such as port scan and contents of the packets. This approach, however, can not detect worms or virus loaded with third party software before it tries to propagate itself through the network.

Since all the system activities are recorded in system log files, many researchers perform intrusion detection by auditing the system log files. However, the delay between the emergence of an intrusion and its detection through auditing of log files can be undesirable. Since the system activities can be modeled as statistical processes, approaches based on statistical method and machine learning methods have been explored. The drawback of using statistical methods is the computation complexity. This may not be critical with desktop systems. In embedded systems, however, resource can be scarce and complexity can be a major issue. In this disclosure, an intrusion detection system is proposed that aims at solving the complexity problem without sacrificing effectiveness.

The statements in this section merely provide background information related to the present disclosure and may not constitute prior art

### SUMMARY

A method is provided for detecting intrusions to a computing environment. The method include: monitoring service requests in the computing environment over a defined period of time; constructing a vector which represents the occurrence of different system calls during the defined time period; and comparing the vector to a plurality of stored vectors, where each of the stored vectors represents system calls made in a potential intrusion.

If a potential intrusion is detected at this stage, then a more complicated detection scheme may be performed by a second detection scheme. For instance, the second detection scheme may assess the temporal sequence in which the system calls were made and/or the system files accessed by the system calls.

Further areas of applicability will become apparent from the description provided herein. It should be understood that the description and specific examples are intended for purposes of illustration only and are not intended to limit the scope of the present disclosure.

### DRAWINGS

FIG. 1 is a diagram of an exemplary intrusion detection system;

FIG. 2 is a diagram of an exemplary vector which represents the occurrence of different system calls; and

FIG. 3 is a diagram of an exemplary vector which represents the occurrence of different system calls and the filed accessed by the system calls.

The drawings described herein are for illustration purposes only and are not intended to limit the scope of the present disclosure in any way.

### DETAILED DESCRIPTION

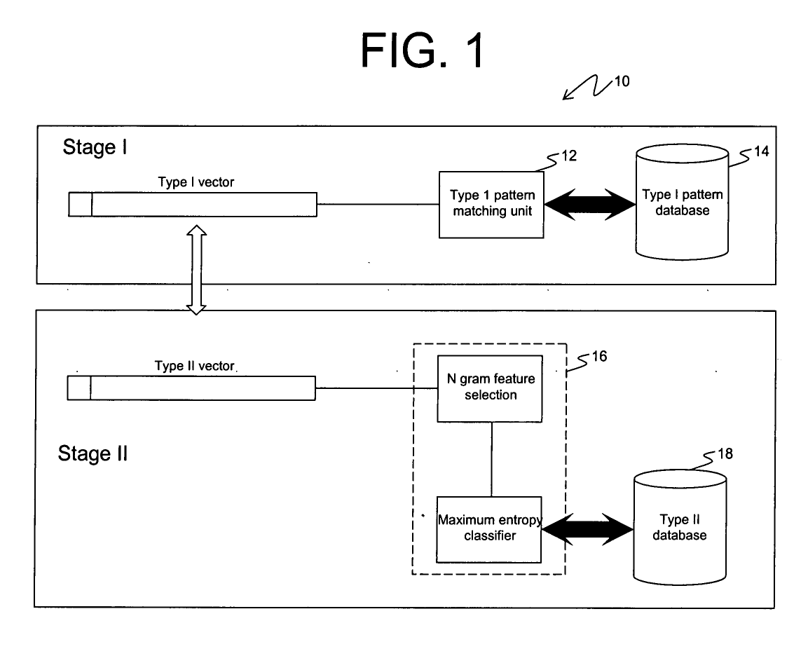

FIG. 1 illustrates an exemplary intrusion detection system 10. The intrusion detection system 10 is comprised generally of a first stage detector 12, a second stage detector 16 and a data store for each detector. The first stage detector 12 uses a simple vector comparison scheme to quickly identify possible intrusions. More specifically, the first stage detector 12 assesses the system calls made during a predefined time period in a manner further described below. If a potential intrusion is detected at this stage, then a more complicated detection scheme may be performed by the second stage detector 16. At this stage, the detector 16 assesses the system files accessed by each system call and the temporal sequence in which the system calls were made. This two-stage detection scheme requires minimal computational resources which makes it particularly suitable for embedded devices.

A system call is the mechanism used by an application program to request service from the operating system. System calls often use a special machine code instruction which causes the processor to change mode (e.g. to “supervisor mode” or “protected mode”). This allows the operating system to perform restricted actions such as accessing hardware devices or the memory management unit. System calls can be used to detect malicious attacks in a computing environment. However, an individual system call does not provide sufficient information. Therefore, the first stage detector examines a collection of system calls which are made within a defined period of time (e.g., 1 millisecond).

In operation, the first stage detector 12 monitors in real-time the system calls made in the computing environment. Most operating systems provide some type of system call interface. For example, in Linux, the system call dispatcher Calls.S may be used by the detector 12 to monitor system calls. In Linux, if the intrusion detection system is implemented as a Linux Security Module, the Security Module places hooks in the system call interface which can be used to monitor system calls. It is understood that this is an implementation detail and that various techniques may be used to monitor system calls in a given computing environment.

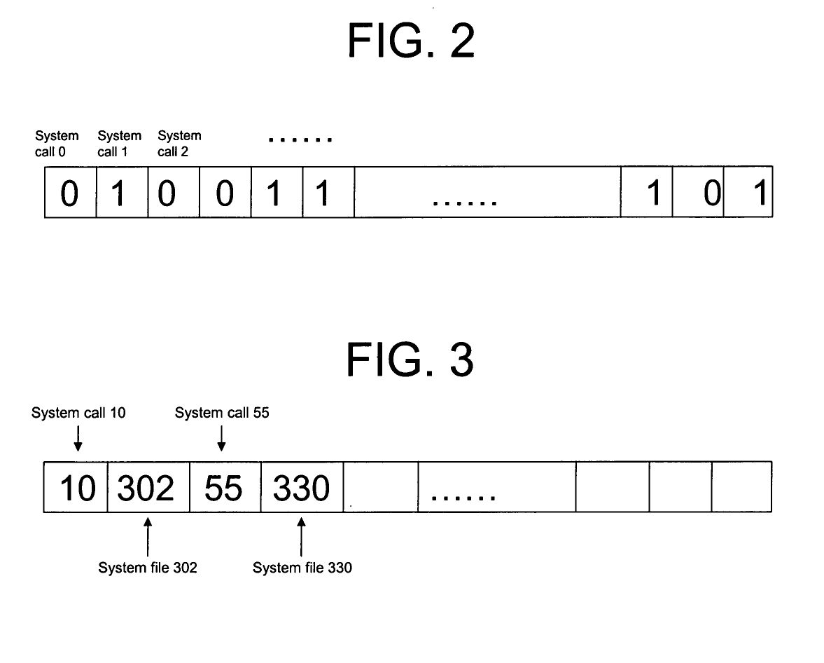

The first stage detector 12 constructs a vector which represents the occurrence of different system calls made during a defined time period. FIG. 2 illustrates an exemplary vector. In this exemplary embodiment, the vector is a one-dimensional array, where each element of the array is indicative of a particular type of system call: For example, element one corresponds to system call 0, element two corresponds to system call 1, element three corresponds to system call 2 and so on. Thus, each available system call in the computing environment correlates to an element in the array. In this exemplary embodiment, each element of the array is a bit having a binary value, such that the bit is set to one when the corresponding system call is made during the time period; otherwise, the bit remains set to zero. Other forms for the vector are contemplated by this disclosure. While the following description has been provided with reference to monitoring vectors over a period of time, it is envisioned that other criteria may be used to reset the collection process. For example, the collection process might be reset once a certain type of vector is detected. In another example, the collection process might be reset once it has been determined that the collected set is irrelevant. Other criteria for resetting the collection process are also within the broader aspects of this disclosure.

Upon reaching the end of the defined time period, the first stage detector 12 then proceeds to compare the constructed vector to a plurality of the vectors residing in a first data store 14. Each vector in the first data store 14 is formulated in the same manner as describe above and represents system calls made during a known malicious intrusion. In the exemplary embodiment, a binary comparison is performed between the constructed vector and the vectors stored in the first data store. Although the comparison is preferably made in real-time, broader aspects of this disclosure envision comparing the constructed vector at some later time.

In addition, the first stage detector 12 continues to monitor in real-time the system calls made in the computing environment. For each subsequent time period, the first stage detector 12 builds another vector and compares the vector to the vectors residing in the first data store in the manner described above. In this way, the intrusion detection system is continually monitoring the computing environment for suspicious intrusions.

Various techniques may be used to improve the comparison process. For example, vectors in the first data store can be pre-sorted so that vectors indicative of more frequently occurring intrusions are sorted to the top of the data store. Once a match is found between the constructed vector and one of the stored vectors, first stage comparison is terminated and processing moves to the second stage.

In another example, the format for the vector may be defined so that system calls which more frequently occur in known intrusions are positioned in the more significant bits of the array. For instance, element one may correlate to system call 55 and element two may correlate to system call 184, where these two system calls are made most often in a malicious intrusion. Once a mismatch is found between the constructed vector and one of the stored vectors, the comparison process can move on to the next vector stored in the data store.

In yet another example, simplified regular expression matching can be employed to perform the necessary vector matching. A regular expression, represented as a string or a set of binary tokens, can be used by the monitor to detect an intrusion. An expression provides a concise description of one or more intrusion patterns without the need to scan for each pattern separately.

To construct the regular expression the formalisms may provide operations for grouping, quantification, and alternation, which can be combined to form complex expressions that describe the intrusion patterns. In addition, the regular expression syntax offers a set of special tokens to describe vectors or group of vectors. For example, the vocabulary and syntax of the string based regular expression could be based on the traditional Unix regular expression syntax, whereas the syntax might include but is not limited to:
. match any vector
* match multiple vectors
? match zero or one vector
+ match one or more vectors
# apply heuristics to a match
   | match alternatives, for example x|y matches x or y
( ) used to define a sub-expression
[ ] match any of the vectors listed within the square brackets
[̂] match any of the vectors not listed within the square brackets
\d match any (known) dangerous vector (vectors that were categorized as dangerous)
\Dx match the dangerous vector <x>, where as <x> is the vector
\i match any (known) irrelevant vector (vectors that were categorized as irrelevant)
\lx match the irrelevant vector <x>, where as <x> is the vector
\f match a any file access (read, write, . . . )
\r match a file read access (any file)
\w match a file write access (any file)
\Fx match the file access to file <x> (read, write, . . . )
\Rx match the file read access to file <x>
\Wx match the file write access to file <x>
\Px match the process with ID <x>
   A pattern to detect write access to the password file by applications/processes that are not related to password management could then look as follows:

[̂\P1]+\i*\W0

whereas [̂\P1]+ describes all processes that do not have ID 1 (ID 1 could denote the password management application); \i* to skip irrelevant vectors if any; and \W0 defines the write access vector to file with ID 0 (ID 0 for files is, in this example, the password file).

The comparison process can be implemented using state machines by compiling regular expressions into binary representations. The vectors are used as input to the state machine for it to advance to different states. Once it arrives at a state that indicates a possible intrusion, further processing is performed by the second stage detector. The advantage of this approach is that only one state per process needs to be stored. Additionally, it is not necessary to store vector information since vectors are encoded into the state machines.

To further increase performance, a simple hash algorithm can be applied to the vectors being compared. If two vectors are equal, then the hash values for the vectors are also equal. Accordingly, a hash algorithm can be applied to the constructed vector and likewise the hash algorithm can be applied to the vectors in the first data store so that hash values as are stored therein. In this case, the first stage detector performs a binary comparison of hash values. Other techniques for improving the comparison process also fall within the scope of this disclosure.

In an alternative approach, FIG. 3 illustrates a second type of vector which may be employed by the intrusion detection system. The second vector type represents system calls as well as the system files accessed by the system calls. In an exemplary embodiment, each system call and system file in the computing environment is assigned a unique identifier. During the monitored time period, the identifier for each system call made is logged in temporal order in the vector. Each system call in the sequence is followed by the identifier for the system file accessed by the associated system call.

In operation, the first stage detector 12 may construct the second type of vector as it monitors in real-time the system calls made in the computing environment. When the first stage detector finds a match for the first type of vector, it invokes the second state detector to further evaluate the second type of vector. If the first stage detector does not find a match for the first type of vector, the computational cost associated with the second stage detection scheme is avoided.

When invoked, the second stage detector 12 compares the second type of constructed vector to a plurality of the vectors residing in a second data store 18. Each vector in the second data store 18 is formulated in the same manner as the second type of vector and represents the temporal sequence in which system calls are made and what files are accessed by each system call during a known malicious intrusion. Although the comparison is preferably made in real-time, broader aspects of this disclosure envision comparing the constructed vector at some later time.

In an exemplary embodiment, the second stage detector 12 may employ a maximum entropy classifier to evaluate the second type of vector. A maximum entropy classifier maximizes entropy and is based on the known without assuming any of the unknown. The principle of maximum entropy classifier is to find the most uniformly distributed model that confirms to the known constrains. Unlike a Bayesian classifier, the maximum entropy classifier does not require the features to be completely independent.

Given a set of training samples T={(x₁, y₁), (x₂, y₂), . . . , (x_{N}, y_{N})} where xᵢ is a real value feature vector and yᵢ is the target domain, the maximum entropy principle states that data T should be summarized with a model that is maximally noncommittal with respect to missing information. Among distributions consistent with the constraints imposed by T, there exists a unique model with highest entropy in the domain of exponential models of the form:

$${P}_{Λ} ( y \vert x ) = \frac{1}{{Z}_{Λ} ( x )} exp [ {\sum }_{i = 1}^{n} {λ}_{i} {f}_{i} ( x , y ) ] \qquad ( 1 )$$

where Λ={λ₁, λ₂, . . . , λₙ} are parameters of the model, fᵢ(x,y)'s are arbitrary feature functions of the model, and

$${Z}_{Λ} ( x ) = {\sum }_{y} exp [ {\sum }_{i = 1}^{n} {λ}_{i} {f}_{i} ( x , y ) ]$$

is the normalization factor to ensure P_{Λ}(y|x) is a probability distribution. The target of the classifier is to find the model that maximizes the conditional entropy:

$$H ( p ) = - \sum \tilde{p} ( x ) p ( y \vert x ) log p ( y \vert x ) , where {p}^{*} = arg max H ( p ) .$$

In this application, the second type of constructed vector serves as the feature vector for the classifier. The classifier is designed to output a probability that the vector is indicative of a malicious intrusion. When the output probability exceeds some predetermine threshold, then further actions may be invoked to particularly identify the type of intrusion or otherwise address the intrusion.

N-grams have proved to be an effective feature extraction tool in high dimensionality feature spaces. An n-gram is a sub-sequence of n items from a given sequence. By converting a sequence of items to a set of n-grams, it can be embed in a vector space, thereby allowing the sequence to be compared to other sequences in an efficient manner. In an exemplary embodiment, an n-gram sequence may be derived from the second type of constructed vector. For example, a tri-gram formed from the vector in FIG. 3 would be (10, 302, 55) (302, 55, 330) (55, 330, . . . ) . . . . The tri-gram would then be used as the feature vector input to the maximum entropy classifier. It should be understood that this is an optional step which may improve the accuracy of the classifier. Moreover, it is understood that the second stage detector may employ other techniques for comparing vectors.

The above description is merely exemplary in nature and is not intended to limit the present disclosure, application, or uses. For instance, it is envisioned that either the first stage detection scheme or the second stage detection scheme may be employed independent of the other stage as a basis for detection intrusions.

What is claimed is:

1. A method for detecting intrusions to a computing environment, comprising:
monitoring service requests in the computing environment over a defined period of time;
constructing a vector which represents the occurrence of different system calls; and
comparing the vector to a plurality of stored vectors, where each of the stored vectors represents system calls made in a potential intrusion.

2. The method of claim 1 wherein constructing a vector further comprises constructing a one-dimensional array, where each element of the array is indicative of a particular type of system call defined in the computing environment.

3. The method of claim 2 wherein each element of the array is one bit, such that the bit is set to one when the system call was made and otherwise the bit is set to zero.

4. The method of claim 3 wherein comparing the vector further comprises performing a binary comparison between the vector and each of the stored vectors.

5. The method of claim 3 further comprises defining a format for the vector where system calls which more commonly occur in potential intrusions are positioned in the more significant bits of the array.

6. The method of claim 1 wherein constructing a vector and comparing the vector occur substantially contemporaneously with monitoring service requests.

7. The method of claim 1 further comprises constructing a second vector which represents system calls and system files accessed by the system call.

8. The method of claim 7 further comprises comparing the second vector to a plurality of stored secondary vectors when the vector matches one of the stored vectors, where each of the secondary vectors represents system calls and system files accessed by the system calls during known intrusions.

9. The method of claim 7 further comprises constructing the second vector such that the system calls are sequenced in a temporal order.

10. The method of claim 9 further comprises constructing the second vector such that each system call in the sequence is followed by the system file accessed by the system call.

11. The method of claim 8 wherein comparing the second vector further comprises inputting the second vector into a maximum entropy classifier, where the plurality of stored secondary vectors serves as training data for the classifier.

12. The method of claim 11 further comprises deriving an n-gram sequence from the second vector and inputting the n-gram sequence into the maximum entropy classifier.

13. A method for detecting intrusions to a computing environment, comprising:
monitoring service requests in the computing environment over a defined period of time;
constructing a vector which represents system calls and system files accessed by the system call during the defined time period; and
comparing the constructed vector to a plurality of stored vectors, where each of the stored vectors represents system calls and system files accessed by the system calls during known intrusions.

14. The method of claim 13 further comprises constructing the vector such that the system calls are sequenced in a temporal order.

15. The method of claim 13 further comprises constructing the vector such that each system call in the sequence is followed by the system file accessed by the system call.

16. The method of claim 13 wherein comparing the second vector further comprises inputting the vector into a maximum entropy classifier.

17. A method for detecting intrusions to a computing environment, comprising:
monitoring system calls made to an operating system during a defined period of time;
evaluating the system calls made during the defined time period in relation to system calls made during known intrusions; and
evaluating the temporal sequence in which system calls were made during the defined time period when the system calls made match the system calls made during a known intrusion.

18. The method of claim 17 further comprises constructing an array which represents the system calls made during the defined time period, where each element of the array corresponds to a particular system call defined in the computing environment, and comparing the array to a plurality of arrays which represent system calls made during known intrusions.

19. The method of claim 17 further comprises constructing a secondary array which represents system calls and system files accessed by the system calls during the defined time period.

20. The method of claim 19 further comprises constructing the secondary array such that the system calls are sequenced in a temporal order in which they were made.

21. The method of claim 19 further comprises inputting the secondary array as a feature vector into a maximum entropy classifier.

22. An intrusion detection system, comprising:
a first data store operable to store a plurality of vectors, where each vector represents system calls made in a potential intrusion
a first stage detector having access to the first data store and operable to monitor system calls made to an operating system, the first stage detector further operable to construct an array which represents system calls made during a defined period of time and compare the array to the plurality of stored vectors to detect a potential intrusion;
a second data store operable to store a plurality of secondary vectors, where each secondary vector represents a temporal order in which system calls are made in a potential intrusion; and
a second stage detector having access to the second data store and operable to evaluate the temporal order system calls were made to the operating system.
